(19) United States
(12) Patent Application Publication
(10) Pub. No.: US 2022/0067739 A1
(43) Pub. Date: Mar. 3, 2022

(54) Method and System for Generating Payment Request Message Based on Preferred Payment Method

(71) Applicant: Visa International Service Association, San Francisco, CA (US)

(72) Inventors: Rohit Sukhija, Bengaluru (IN); Pragathi M S, Bangalore (IN)

(21) Appl. No.: 17/005,680

(22) Filed: Aug. 28, 2020

(51) Int. Cl. G06Q 20/40; G06Q 20/22

(52) U.S. Cl. CPC G06Q 20/4097; G06Q 20/407; G06Q 20/227

(57) ABSTRACT

A computer-implemented method for generating a payment request message based on a preferred payment method is proposed. The computer system facilitates communication of transaction messages between a merchant server and an interoperability server. A first payment request message is received from the merchant server for transaction between a user and a merchant. A payment method is selected from a group comprising a plurality of merchant preferred payment methods and a plurality of user preferred payment methods obtained from a database. The selection is based on at least one of transaction information in the first payment request message and one or more rules. A second payment request message is generated in the selected payment method. The second payment request message is provided to the interoperability server. The transaction is processed in the selected payment method.

### BACKGROUND

### 1. Technical Field

The present disclosure relates generally to real-time transactions, and more specifically, to a method and system for generating a payment request message based on a preferred payment method.

### 2. Technical Considerations

Real-time transactions are electronic money transfers made from one person (a sender) to another person (a receiver), for instance, between a user and a merchant. The real-time transactions allow users to transfer funds immediately from their bank account to a merchant's account. In few existing systems, the user is forced to make payments using payment methods offered by the merchant. Also, the merchant must continuously add new payment connections and maintain payment preferences per user.

In existing methods, there is no single system that can process multiple payments through different payment methods independent of a merchant set choice. Therefore, there is a need to define payment methods as per user and merchant preferences.

The information disclosed in the background of the disclosure section is only for enhancement of understanding of the general background of the disclosure and should not be taken as an acknowledgement or any form of suggestion that this information forms the existing information already known to a person skilled in the art.

### SUMMARY

Additional features and advantages are realized through the techniques of the present disclosure. Other embodiments and aspects of the disclosure are described in detail herein and are considered a part of the claimed disclosure.

In some non-limiting embodiments or aspects, provided is a computer-implemented method, wherein a computer system facilitates communication of transaction messages between a merchant server and an interoperability server, the method comprising: receiving a first payment request message from the merchant server, wherein the first payment request message is generated for a transaction between a user and a merchant; selecting a payment method from a group comprising a plurality of merchant preferred payment methods and a plurality of user preferred payment methods, wherein the selection is based on at least one of the following: transaction information in the first payment request message, one or more rules, or any combination thereof, wherein the plurality of merchant preferred payment methods and the plurality of user preferred payment methods are obtained from a database; and generating a second payment request message in the selected payment method, wherein the second payment request message is provided to an interoperability server, wherein the transaction is processed in the selected payment method.

In some non-limiting embodiments or aspects, the transaction information in the first payment request message comprises at least one of the following: identity details of the user, a type of the transaction, a transaction amount, a transaction currency, a timestamp of the transaction, location details of the transaction, details of the merchant, a type of merchandise, or any combination thereof. In some non-limiting embodiments or aspects, the one or more rules comprise at least one of the following: a priority associated with the preferred payment method, one or more business rules, one or more regulatory rules, or any combination thereof. In some non-limiting embodiments or aspects, the computer-implemented method comprises: receiving a payment response message in a first format from the interoperability server after the transaction is processed; converting the payment response message in the first format to a second format recognized by the merchant server; and sending the payment response message in the second format to the merchant server.

In some non-limiting embodiments or aspects, the computer-implemented method further comprises selecting a first alternate payment method from the group, based on the one or more rules, to complete the transaction when the transaction performed using the selected payment method is declined. In some non-limiting embodiments or aspects, the computer-implemented method further comprises providing at least one of the following: a refund of a transaction amount to an account associated with the user in the selected payment method; a chargeback of the transaction amount to an account associated with the merchant in the selected payment method, or any combination thereof. In some non-limiting embodiments or aspects, the computer-implemented method further comprises selecting a second alternate payment method from the group for providing the chargeback or the refund of the transaction amount based on the one or more rules, when the chargeback or the refund of the transaction amount is not completed in the selected payment method, respectively.

In some non-limiting embodiments or aspects, provided is a computer-implemented method comprising: receiving a plurality of user preferred payment methods along with information related to the plurality of user preferred payment methods from a user, wherein the information related to the plurality of user preferred payment methods comprises at least one of the following: a priority associated with each of the plurality of user preferred payment methods, a type of a transaction, an amount of the transaction, a type of merchandise, a type of a merchant, or any combination thereof; receiving a plurality of merchant preferred payment methods along with information related to the plurality of merchant preferred payment methods from a merchant, wherein the information related to the plurality of merchant preferred payment methods comprises at least one of the following: a priority associated with each of the plurality of merchant preferred payment methods, a type of a transaction, a type of merchandise, location of a transaction, a timestamp of the transaction, an amount of the transaction, or any combination thereof; and registering the plurality of user preferred payment methods along with the information related to the plurality of user preferred payment methods and the plurality of merchant preferred payment methods along with the information related to the plurality of merchant preferred payment methods in a database, wherein the plurality of preferred payment methods is used to generate a request message during a transaction between the user and the merchant.

In some non-limiting embodiments or aspects, provided is a computer system for facilitating communication of transaction messages between a merchant server and an interoperability server, the computer system comprising: one or more processors, and a memory, wherein the memory stores processor-executable instructions, which, upon execution, cause the one or more processors to: receive a first payment request message from the merchant server, wherein the first payment request message is generated for a transaction between a user and a merchant; select a payment method from a group comprising a plurality of merchant preferred payment methods and a plurality of user preferred payment methods, wherein the selection is based on at least one of the following: transaction information in the first payment request message; one or more rules, or any combination thereof, wherein the plurality of merchant preferred payment methods and the plurality of user preferred payment methods are obtained from a database; and generate a second payment request message in the selected payment method, wherein the second payment request message is provided to an interoperability server, wherein the transaction is processed in the selected payment method.

In some non-limiting embodiments or aspects, the one or more processors are further configured to: receive a payment response message in a first format from the interoperability server after the transaction is processed; convert the payment response message in the first format to a second format recognized by the merchant server; and send the payment response message in the second format to the merchant server. In some non-limiting embodiments or aspects, the one or more processors are further configured to select a first alternate payment method from the group, based on the one or more rules, to complete the transaction when the transaction performed using the selected payment method is declined.

In some non-limiting embodiments or aspects, the one or more processors are further configured to provide at least one of the following: a refund of a transaction amount to an account associated with the user in the selected payment method; a chargeback of the transaction amount to an account associated with the merchant in the selected payment method, or any combination thereof. In some non-limiting embodiments or aspects, the one or more processors are further configured to select a second alternate payment method from the group for providing the chargeback or the refund of the transaction amount based on the one or more rules, when the chargeback or the refund of the transaction amount is not completed in the selected payment method, respectively.

Further non-limiting embodiments or aspects are set forth in the following numbered clauses:

Clause 1: A computer-implemented method, wherein a computer system facilitates communication of transaction messages between a merchant server and an interoperability server, the method comprising: receiving a first payment request message from the merchant server, wherein the first payment request message is generated for a transaction between a user and a merchant; selecting a payment method from a group comprising a plurality of merchant preferred payment methods and a plurality of user preferred payment methods, wherein the selection is based on at least one of the following: transaction information in the first payment request message; one or more rules, or any combination thereof, wherein the plurality of merchant preferred payment methods and the plurality of user preferred payment methods are obtained from a database; and generating a second payment request message in the selected payment method, wherein the second payment request message is provided to an interoperability server, wherein the transaction is processed in the selected payment method.

Clause 2: The computer-implemented method of clause 1, wherein the transaction information in the first payment request message comprises at least one of the following: identity details of the user, a type of the transaction, a transaction amount, a transaction currency, a timestamp of the transaction, location details of the transaction, details of the merchant, a type of merchandise, or any combination thereof.

Clause 3: The computer-implemented method of clause 1 or 2, wherein the one or more rules comprise at least one of the following: a priority associated with a preferred payment method, one or more business rules, one or more regulatory rules, or any combination thereof.

Clause 4: The computer-implemented method of any of clauses 1-3, further comprising: receiving a payment response message in a first format from the interoperability server after the transaction is processed; converting the payment response message in the first format to a second format recognized by the merchant server; and sending the payment response message in the second format to the merchant server.

Clause 5: The computer-implemented method of any of clauses 1-4, further comprising selecting a first alternate payment method from the group, based on the one or more rules, to complete the transaction when the transaction performed using the selected payment method is declined.

Clause 6: The computer-implemented method of any of clauses 1-5, further comprising providing at least one of the following: a refund of a transaction amount to an account associated with the user in the selected payment method, a chargeback of the transaction amount to an account associated with the merchant in the selected payment method, or any combination thereof.

Clause 7: The computer-implemented method of any of clauses 1-6, further comprising selecting a second alternate payment method from the group for providing the chargeback or the refund of the transaction amount based on the one or more rules, when the chargeback or the refund of the transaction amount is not completed in the selected payment method, respectively.

Clause 8: A computer-implemented method comprising: receiving a plurality of user preferred payment methods along with information related to the plurality of user preferred payment methods from a user, wherein the information related to the plurality of user preferred payment methods comprises at least one of the following: a priority associated with each of the plurality of user preferred payment methods, a type of a transaction, an amount of the transaction, a type of merchandise, a type of a merchant, or any combination thereof; receiving a plurality of merchant preferred payment methods along with information related to the plurality of merchant preferred payment methods from a merchant, wherein the information related to the plurality of merchant preferred payment methods comprises at least one of the following: a priority associated with each of the plurality of merchant preferred payment methods, a type of a transaction, a type of merchandise, location of a transaction, a timestamp of the transaction, an amount of the transaction, or any combination thereof; and registering the plurality of user preferred payment methods along with the information related to the plurality of user preferred payment methods and the plurality of merchant preferred payment methods along with the information related to the plurality of merchant preferred payment methods in a database, wherein the plurality of preferred payment methods is used to generate a request message during a transaction between the user and the merchant.

Clause 9: A computer system for facilitating communication of transaction messages between a merchant server and an interoperability server, the computer system comprising: one or more processors, and a memory, wherein the memory stores processor-executable instructions, which, upon execution, cause the one or more processors to: receive a first payment request message from the merchant server, wherein the first payment request message is generated for a transaction between a user and a merchant; select a payment method from a group comprising a plurality of merchant preferred payment methods and a plurality of user preferred payment methods, wherein the selection is based on at least one of the following: transaction information in the first payment request message; one or more rules, or any combination thereof, wherein the plurality of merchant preferred payment methods and the plurality of user preferred payment methods are obtained from a database; and generate a second payment request message in the selected payment method, wherein the second payment request message is provided to an interoperability server, wherein the transaction is processed in the selected payment method.

Clause 10: The computer system of clause 9, wherein the one or more processors are further configured to: receive a payment response message in a first format from the interoperability server after the transaction is processed; convert the payment response message in the first format to a second format recognized by the merchant server; and send the payment response message in the second format to the merchant server.

Clause 11: The computer system of clause 9 or 10, wherein the one or more processors are further configured to select a first alternate payment method from the group, based on the one or more rules, to complete the transaction when the transaction performed using the selected payment method is declined.

Clause 12: The computer system of any of clauses 9-11, wherein the one or more processors are further configured to provide at least one of the following: a refund of a transaction amount to an account associated with the user in the selected payment method, a chargeback of the transaction amount to an account associated with the merchant in the selected payment method, or any combination thereof.

Clause 13: The computer system of any of clauses 9-12, wherein the one or more processors are further configured to select a second alternate payment method from the group for providing the chargeback or the refund of the transaction amount based on the one or more rules, when the chargeback or the refund of the transaction amount is not completed in the selected payment method, respectively.

In some non-limiting embodiments or aspects, a computer-implemented method for generating payment request message based on preferred payment method is proposed. A computer system facilitates communication of transaction messages between a merchant server and an interoperability server. The method comprises receiving a first payment request message from the merchant server. The first payment request message is generated for a transaction between a user and a merchant. Further, the method comprises selecting a payment method from a group comprising a plurality of merchant preferred payment methods and a plurality of user preferred payment methods. The selection is based on at least one of transaction information in the first payment request message and one or more rules. The plurality of merchant preferred payment methods and the plurality of the user preferred payment methods are obtained from a database. Furthermore, the method comprises generating a second payment request message in the selected payment method. The second payment request message is provided to an interoperability server. The transaction is processed in the selected payment method.

In some non-limiting embodiments or aspects, a computer-implemented method is proposed. The method comprises receiving a plurality of user preferred payment methods along with information related to the plurality of user preferred payment methods from a user. The information related to the plurality of user preferred payment methods comprises at least one of a priority associated with each of the plurality of user preferred payment methods, a type of a transaction, an amount of the transaction, a type of merchandise, and a type of a merchant. Further, the method comprises receiving a plurality of merchant preferred payment methods along with information related to the plurality of merchant preferred payment methods from a merchant. The information related to the plurality of merchant preferred payment methods comprises at least one of a priority associated with each of the plurality of merchant preferred payment methods, a type of a transaction, a type of merchandise, location of a transaction, a timestamp of the transaction, and an amount of the transaction. Furthermore, the method comprises registering the plurality of user preferred payment methods along with the information related to the plurality of user preferred payment methods and the plurality of merchant preferred payment methods along with the information related to the plurality of merchant preferred payment methods in a database. The plurality of preferred payment methods is used to generate a request message during a transaction between the user and the merchant.

In some non-limiting embodiments or aspects, a computer system for facilitating communication of transaction messages between a merchant server and an interoperability server is proposed. The computer system comprises one or more processors and a memory communicatively coupled with the one or more processors. The one or more processors are configured to receive a first payment request message from the merchant server. The first payment request message is generated for a transaction between a user and a merchant. Further, the one or more processors are configured to select a payment method from a group comprising a plurality of merchant preferred payment methods and a plurality of user preferred payment methods. The selection is based on at least one of transaction information in the first payment request message and one or more rules. The plurality of merchant preferred payment methods and the plurality of the user preferred payment methods are obtained from a database. Furthermore, the one or more processors are configured to generate a second payment request message in the selected payment method. The second payment request message is provided to an interoperability server. The transaction is processed in the selected payment method.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, may best be understood by reference to the following detailed description of non-limiting embodiments or aspects when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments or aspects are now described, by way of example only, with reference to the accompanying figures wherein like reference numerals represent like elements and in which:

FIG. 1 is an exemplary platform for performing transactions based on preferred payment method, in accordance with some non-limiting embodiments or aspects of the present disclosure;

FIG. 2 is a flow chart illustrating a method for registering a plurality of user preferred payment methods and a plurality of merchant preferred payment methods in a database, in accordance with some non-limiting embodiments or aspects of the present disclosure;

FIG. 3A is an exemplary registration of the plurality of user preferred payment methods and the plurality of merchant preferred payment methods in the database, in accordance with some non-limiting embodiments or aspects of the present disclosure;

FIGS. 3B-3D is an exemplary portal for providing the plurality of user preferred payment methods and the plurality of merchant preferred payment methods, in accordance with some non-limiting embodiments or aspects of the present disclosure;

FIG. 4 is a flow chart illustrating a method for generating a payment request message based on a preferred payment method, in accordance with some non-limiting embodiments or aspects of the present disclosure;

FIG. 5 is an exemplary sequence diagram for generating a payment request message based on a preferred payment method, in accordance with some non-limiting embodiments or aspects of the present disclosure; and

FIG. 6 is a block diagram of a general-purpose computer system for generating payment request message based on a preferred payment method, in accordance with some non-limiting embodiments or aspects of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the term “exemplary” is used herein to mean “serving as an example, instance, or illustration.” Any embodiment, aspect, or implementation of the present subject matter described herein as “exemplary” is not necessarily to be construed as preferred or advantageous over other embodiments.

In the following detailed description of non-limiting embodiments or aspects of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

The terms “comprises”, “comprising”, or any other variations thereof are intended to cover a non-exclusive inclusion such that a setup, device, or method that comprises a list of components or steps does not include only those components or steps but may include other components or steps not expressly listed or inherent to such setup, device, or method. In other words, one or more elements in a system or apparatus proceeded by “comprises . . . a” do not, without more constraints, preclude the existence of other elements or additional elements in the system or method.

The terms “includes”, “including”, or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” do not, without more constraints, preclude the existence of other elements or additional elements in the system or method.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/feature. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices or computing units, such as processors, storage devices, and/or similar computer components, that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present disclosure relate to a method and a computer system for generating a payment request message. The computer system aids in generating the payment request message based on a preferred payment method for a transaction between a user and a merchant. A plurality of user preferred payment methods and a plurality of merchant preferred payment methods are registered in a database. When the transaction is initiated, a merchant server associated with the merchant transmits a payment request message for processing the transaction. In traditional techniques, a default payment method was selected or the user selected a payment method during checkout in merchant page, and a payment request message was generated accordingly. In the present disclosure, the computer system residing between the merchant server and the interoperability server selects a preferred payment method from the plurality of user preferred payment methods and a plurality of merchant preferred payment methods in the database. The computer system generates a payment request message in the selected preferred payment method and provides the payment request message in the selected preferred payment method to the interoperability server for processing the transaction. Hence, using the methods of the present disclosure, the user can set preferences at various levels and merchants can set their preferences of payment methods that the merchants are willing to accept payments from users.

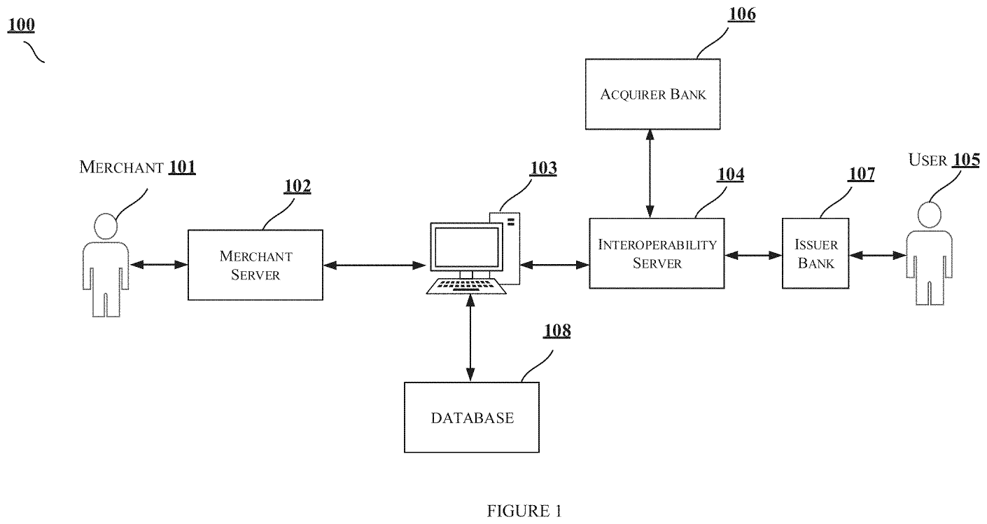

FIG. 1 describes an overview of a platform (100) for performing transactions based on preferred payment method. The platform (100) is provided as a service to a merchant (101) and a user (105) to enable the merchant (101) and the user (105) to perform transactions. The platform (100) is provided to perform payments at merchant checkout pages in online payment transactions and merchant terminals in offline payment transactions. The present disclosure pertains to real-time transactions. The platform (100) comprises a merchant server (102), an acquirer bank (106), a computer system (103), an interoperability server (104), and an issuer bank (107). The merchant (101) may be a person receiving an amount from the user (105). The merchant server (102) is an entity associated with the merchant (101) that provides payment services to the merchant (101). The merchant server (102) provides back-end services associated with the bank of the merchant (101). The acquirer bank (106) is a financial institution that processes credit or debit card payments on behalf of the merchant (101). The computer system (103) may be a gateway which resides in a payment network. The computer system (103) connects the merchant server (102) and the interoperability server (104). Typically, a default payment method is selected, or the user (105) selects a payment method during checkout in a merchant page, and a payment request message is generated accordingly. In the present disclosure, the computer system (103) residing between the merchant server (102) and the interoperability server (104) selects a preferred payment method from the plurality of user preferred payment methods and a plurality of merchant preferred payment methods in a database (108).

In some non-limiting embodiments or aspects, the preferred payment method may be a merchant preferred payment method or a user preferred payment method. The interoperability server (104) may process transactions between the merchant (101) and the user (105) via the computer system (103). The interoperability server (104) may receive the second payment request message in the preferred payment method from the computer system (103) to process the transaction. In some non-limiting embodiments or aspects, the interoperability server (104) may facilitate the transaction between various issuer banks and acquirer banks. For example, the interoperability server (104) may be managed by institutions such as Visa®. The issuer bank (107) provides banking services to the user (105), allowing the user (105) to initiate purchases using different payment options. The user (105) may avail the banking services by creating an account in the issuer bank (107).

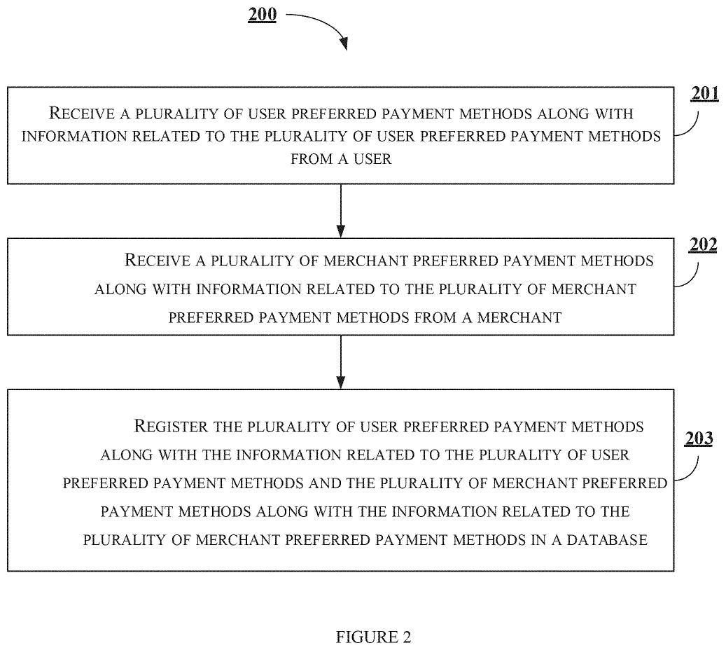

FIG. 2 shows a flow chart illustrating a method for registering a plurality of user preferred payment methods and a plurality of merchant preferred payment methods in the database (108), in accordance with some non-limiting embodiments or aspects of the present disclosure. As illustrated in FIG. 2, the method (200) may comprise one or more steps. The method (200) may be described in the general context of computer executable instructions. Generally, computer executable instructions can include routines, programs, objects, components, data structures, procedures, modules, and functions, which perform particular functions or implement particular abstract data types.

The order in which the method (200) is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step (201), the method may include receiving a plurality of user preferred payment methods along with information related to the plurality of user preferred payment methods from the user (105). There are several payment methods which the user (105) can use for making payments to the merchant (101). For example, the payment methods may include, but are not limited to, debit card payment, credit card payment, wallet-based payment, bank transfer, and the like. In one example, the user (105) may be using only a default payment method such as a debit card for all of the payments. In another example, the user (105) may be using different payment methods based on the type of purchase, amount of the purchase, and the like. The computer system (103) may receive the plurality of user preferred payment methods from the user (105) and store the same in the database (108). For example, a dedicated portal or a form may be used to collect the user payment preferences. During a transaction in real-time, the stored user preferences may be considered for completing the transaction. The user (105) may provide the plurality of user preferred payment methods through a user interface.

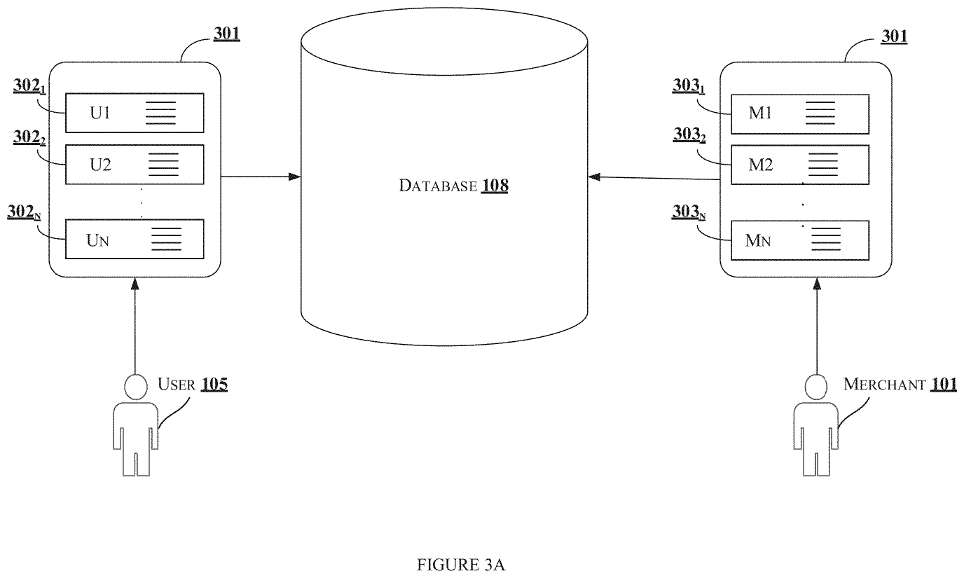

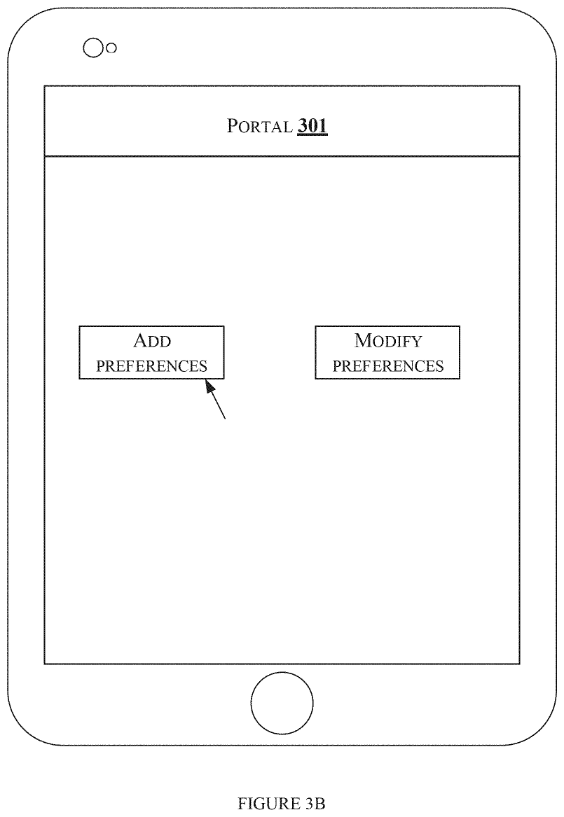

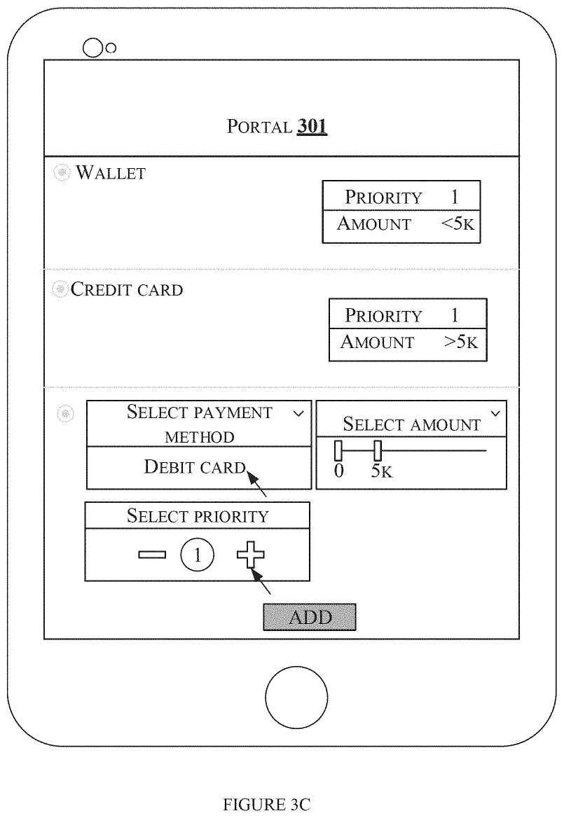

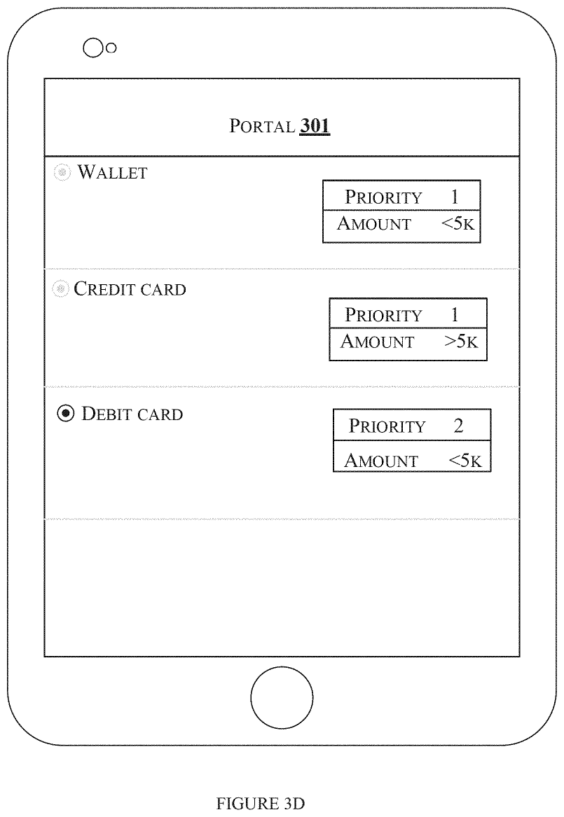

In some non-limiting embodiments or aspects, the user interface may be provided specific to a merchant on the merchant check-out page or a generic user interface may be provided that receives the user preferences for all merchants. For example, a Uniform Resource Locator (URL) on a merchant website may be provided to the user (105) to access a portal for providing the plurality of user preferred payment methods for the merchant. FIG. 3A illustrates a portal (301) which is provided to the user (105). The user (105) may log in to the portal (301) and provide a plurality of user preferred payment methods (302₁, 302₂, . . . 302ₙ). The user (105) may provide information related to the plurality of user preferred payment methods (302₁, 302₂, . . . 302ₙ). The information related to the plurality of user preferred payment methods (302₁, 302₂, . . . 302ₙ) may comprise at least one of a priority associated with each of the plurality of user preferred payment methods (302₁, 302₂, . . . 302ₙ), a type of a transaction, an amount of the transaction, a type of merchandise, and a type of a merchant (101). For example, the user (105) may set the preferred payment method based on the type of merchandise. The user (105) may set a wallet transfer payment as the preferred payment method for clothing. The user (105) may set a credit card payment as the preferred payment method for household electronic products.

Referring back to FIG. 2, at step (202), the method may include receiving a plurality of merchant preferred payment methods (303₁, 303₂, . . . 303ₙ) along with information related to the plurality of merchant preferred payment methods (303₁, 303₂, . . . 303ₙ) from the merchant (101). The computer system (103) may receive the plurality of merchant preferred payment methods (303₁, 303₂, . . . 303ₙ) from the merchant (101). Hence, using the present disclosure, when the transaction is processed, merchant preferences may be considered. Referring back to FIG. 3A, the merchant (101) may log in to the portal (301) and provide the plurality of merchant preferred payment methods (303₁, 303₂, . . . 303ₙ). The merchant (101) may further provide information related to the plurality of merchant preferred payment methods (302₁, 302₂, . . . 302ₙ). The information related to the plurality of merchant preferred payment methods (303₁, 303₂, . . . 303ₙ) may comprise at least one of a priority associated with each of the plurality of merchant preferred payment methods (303₁, 303₂, . . . 303ₙ), a type of a transaction, a type of merchandise, location of a transaction, a timestamp of the transaction, and an amount of the transaction. For example, the merchant (101) may set the preferred payment method based on the location of the transaction. The merchant (101) may set a non-refundable payment method for delivering a merchandise to a distant location. In another example, the merchant (101) may set the preferred payment method based on the amount of the transaction. The merchant (101) may set the preferred payment method as a wallet payment for the amount less than 5000 United States Dollars (USD).

At step (203) of FIG. 2, the method may include registering the plurality of user preferred payment methods (302₁, 302₂, . . . 302ₙ) along with the information related to the plurality of user preferred payment methods (302₁, 302₂, . . . 302ₙ) and the plurality of merchant preferred payment methods (303₁, 303₂, . . . 303ₙ) along with the information related to the plurality of merchant preferred payment methods (303₁, 303₂, . . . 303ₙ) in the database (108). The plurality of user preferred payment methods (302₁, 302₂, . . . 302ₙ) and the plurality of merchant preferred payment methods (303₁, 303₂, . . . 303ₙ) may be registered in the database (108). The database (108) may be hosted in the computer system (103) or a server (not shown) associated with the computer system (103). Referring again to FIG. 3A, the plurality of user preferred payment methods (302₁, 302₂, . . . 302ₙ) and the plurality of merchant preferred payment methods (303₁, 303₂, . . . 303ₙ) are registered in the database (108). The computer system (103) may retrieve the plurality of preferred payment methods to generate a request message during a transaction between the user (105) and the merchant (101).

In some non-limiting embodiments or aspects, the plurality of user preferred payment methods (302₁, 302₂, . . . 302ₙ) is updated when the user (105) selects a payment method in a merchant checkout page. For example, when the user (105) is checking out in a new merchant page (merchant not listed in user preferences), the payment method selected by the user (105) is recorded against the new merchant and the selected payment method may be stored in the database (108) when the merchants send payment processing calls to the computer system (103).

FIGS. 3B-3C illustrate an exemplary portal (301). The foregoing description of FIGS. 3B-3C is provided for adding user preferences. A person of ordinary skill will appreciate that similar portals can be implemented for adding merchant preferences by making suitable changes in the portal. As shown in FIG. 3B, the portal (301) may provide options such as “add preferences” and “modify preferences”. The user (105) may select the “add preferences” option to add payment preferences. As shown in FIG. 3C, the portal (301) may show all of the existing user preferred payment methods like a wallet transfer payment having a first priority for a transaction amount less than 5000 USD, a credit card payment having a first priority for a transaction amount greater than 5000 USD. The portal (301) may provide options such as “select payment method”, “select priority”, and “select amount”. The user (105) may select debit card payment by selecting the “select payment method” option. The user (105) may select a priority as a second priority by selecting “+” in the “select priority” option. The user (105) may select an amount of the transaction by selecting the “select amount”. The user (105) may select the add option. The preferred payment method is added in the portal (301) as shown in FIG. 3D. Similarly, the merchant (101) provides the plurality of merchant preferred methods in the portal (301).

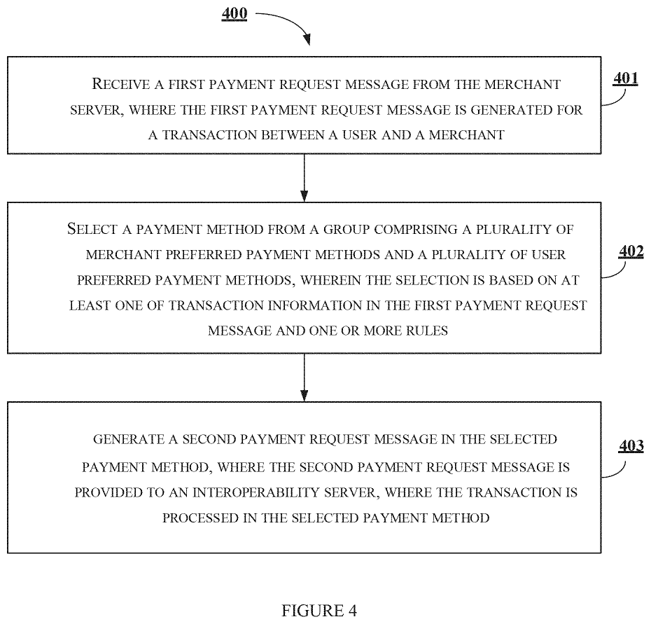

FIG. 4 shows a flow chart illustrating a method for generating a payment request message based on a preferred payment method, in accordance with some non-limiting embodiments or aspects of the present disclosure. As illustrated in FIG. 4, the method (400) may comprise one or more steps. The method (400) may be described in the general context of computer executable instructions. Generally, computer executable instructions can include routines, programs, objects, components, data structures, procedures, modules, and functions, which perform particular functions or implement particular abstract data types.

The order in which the method (400) is described is not intended to be construed as a limitation, and any number of the described method blocks can be combined in any order to implement the method. Additionally, individual blocks may be deleted from the method without departing from the spirit and scope of the subject matter described herein. Furthermore, the method can be implemented in any suitable hardware, software, firmware, or combination thereof.

At step (401), the method may include receiving a first payment request message from the merchant server (102), where the first payment request message is generated for the transaction between the user (105) and the merchant (101). A payment request message contains identifiers used to retrieve information about the payment. The first payment request message comprises transaction information. The transaction information may comprise identity details of the user (105), a type of the transaction, a transaction amount, a transaction currency, a timestamp of the transaction, location details of the transaction, details of the merchant (101), and a type of merchandise. The first payment request message is transmitted by the merchant server (102) to the computer system (103). An exemplary first payment request message may be as shown in Table 1 below.

TABLE 1

PaymentRequestName=Sale
CustomerCity=Mountain View
CustomerCountry=US
CustomerEmail=customer@merchant.com
CustomerFirstName=John
CustomerLastName=Doe
CustomerPostalCode=94043
Customer State=CA
InvoiceHeader =World largest online store
merchantID=merchant123
MerchantReferenceCode=refnum1234
PurchaseCurrency=USD
PurchaseTotalAmount=19.99

At step (402), the method may include selecting a payment method from a group comprising the plurality of merchant preferred payment methods (303₁, 303₂, . . . 303ₙ) and the plurality of user preferred payment methods (302₁, 302₂, . . . 302ₙ), where the selection is based on at least one of the transaction information in the first payment request message and one or more rules. The plurality of merchant preferred payment methods (303₁, 303₂, . . . 303ₙ) and the plurality of user preferred payment methods (302₁, 302₂, . . . 302ₙ) are obtained from the database (108) by the computer system (103) to select a payment method for completing the transaction. The selection of the payment method may be made based on at least one of the transaction information in the first payment request message and the one or more rules. For example, the amount of the transaction in the transaction message may be 300 USD.

The user preferred payment method may be a wallet-based transfer and the merchant preferred payment method may be a credit card payment. Further, the selection is based on the one or more rules. The one or more rules (not shown in figures) may be stored in the database (108). The one or more rules comprise at least one of a priority associated with the preferred payment method, one or more business rules, and one or more regulatory rules. The user preferred payment method may be selected over the merchant preferred payment method according to the one or more business rules. In an example, the transaction may be a gold purchase. The user preferred payment method may be a credit card payment for gold purchases. The merchant preferred payment method may be a bank transfer. The one or more regulatory rules in the region of the purchase of gold may mandate the use of a bank transfer for gold purchases. Hence, the merchant preferred payment method may be selected over the user preferred payment method according to the one or more regulatory rules.

At step (403), the method may include generating a second payment request message in the selected payment method, where the second payment request message is provided to an interoperability server (104), and where the transaction is processed in the selected payment method. The computer system (103) facilities communication of transaction messages between the merchant server (102) and the interoperability server (104). The computer system (103) may generate the second payment request in the selected payment method. The computer system (103) may add necessary fields related to the selected payment method in the second payment request message. An exemplary second payment request message is shown in Table 2 below. The second payment request message is generated in the selected payment method, in this instance, the credit card payment. The second payment request message comprises fields like a credit card number of the user (105), a timestamp of the transaction, and the like. The second payment request message generated is according to ISO 8583 standard. A person skilled in the art will appreciate that the payment request message may be generated according to any other standards.

TABLE 2
<field id=“0” value=“0100”/> // message type indicator - 0100 is an authorization
message
<field id=“2” value=“4111111111111111”/> //customer's credit card number
<field id=“3” value=“000000”/> //processing code
<field id=“4” value=“000000023000”/> //amount
<field id=“7” value=“0605172609”/> //date and time
<field id=“11” value=“155830”/> // STAN - system trace audit number
<field id=“19” value=“840”/> //Acquirer ID
<field id=“25” value=“59”/> / PoS condition code
<field id=“40” value=“merchant123”/> //Merchant ID
<field id=“51” value=“840”/> //currency code

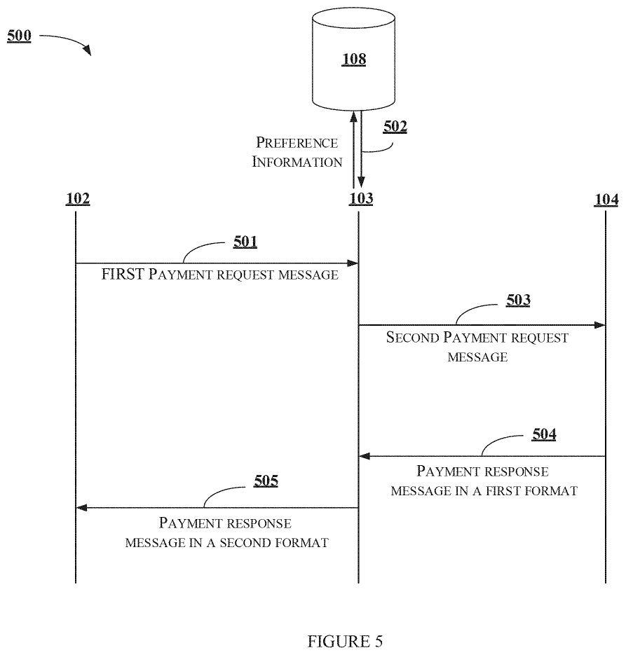

Reference is now made to FIG. 5, illustrating an exemplary sequence diagram (500) for generating a payment request message based on preferred payment method. Consider a transaction between the merchant (101) and user (105). The merchant server (102) sends a first payment request message (501) to the computer system (103). The computer system (103) retrieves preference information (502) from the database (108) and selects the payment method based on the transaction information and the one or more rules. The computer system (103) generates the second payment request message (503) for the selected payment method. The computer system (103) provides a second payment request message (503) to the interoperability server (104). The interoperability server (104) forwards the second payment request message (503) to the issuer bank (107). The issuer bank (107) processes the transaction in the selected payment method by retrieving details provided in the second payment request message (503). The issuer bank (107) generates a payment response message (504) in a first format after the transaction is processed. The payment response message (504) may provide a status of the transaction as success, pending, or fail and other details of the transaction. For example, the other details may include a timestamp of the transaction.

The interoperability server (104) forwards the payment response message (504) in the first format to the computer system (103). The computer system (103) may convert the payment response message (504) in the first format to a payment response message (505) in a second format recognized by the merchant server (102). The payment response message (505) in the second format may be used for purposes such as dispute management, refunds, chargebacks, and settlement information. The first format may be the International Organization for Standardization (ISO) 8583 format. An exemplary payment response message in the second format is shown in the Table 3 below.

TABLE 3

PaymentResponseName=Authorization

PaymentResponseStatus=Success
MethodReversible=Yes
ChargebackRights=Partial
MethodRefundable=Yes
MethodReversalTime=5
MethodSettlementTime=2
MerchantFurtherAction=NotRequired

In some non-limiting embodiments or aspects, the computer system (103) selects a first alternate payment method from the group, based on the one or more rules, to complete the transaction when the transaction performed using the selected payment method is declined. For example, the payment response message from the interoperability server (104) may indicate a status of the transaction as “declined” when the transaction is processed using a first user preferred payment method as wallet-based transfer. The computer system (103) may select a second user preferred payment method as a debit card for completing the transaction.

In some non-limiting embodiments or aspects, the computer system (103) provides one of a refund of a transaction amount to an account associated with the user (105) in the selected payment method and a chargeback of the transaction amount to an account associated with the merchant (101) in the selected payment method. The computer system (103) may select a second alternate payment method from the group for providing the chargeback or the refund of the transaction amount based on the one or more rules, when the chargeback or the refund of the transaction amount is not completed in the selected payment method, respectively.

The present disclosure provides a single system that can process payments through different payment methods. The user (105) can set preferences at various levels of preferences and the merchant (101) can set their preferences of payment methods that the merchant (101) is willing to accept from the user (105) to pay. In addition, the user (105) need not worry about payment method configurations at the merchant level. This would provide a simple and easy commerce experience across the merchants. The merchant is agnostic to the payment method used. Hence, the merchant (101) need not add new payment connections according to the payment methods used by the user (105).

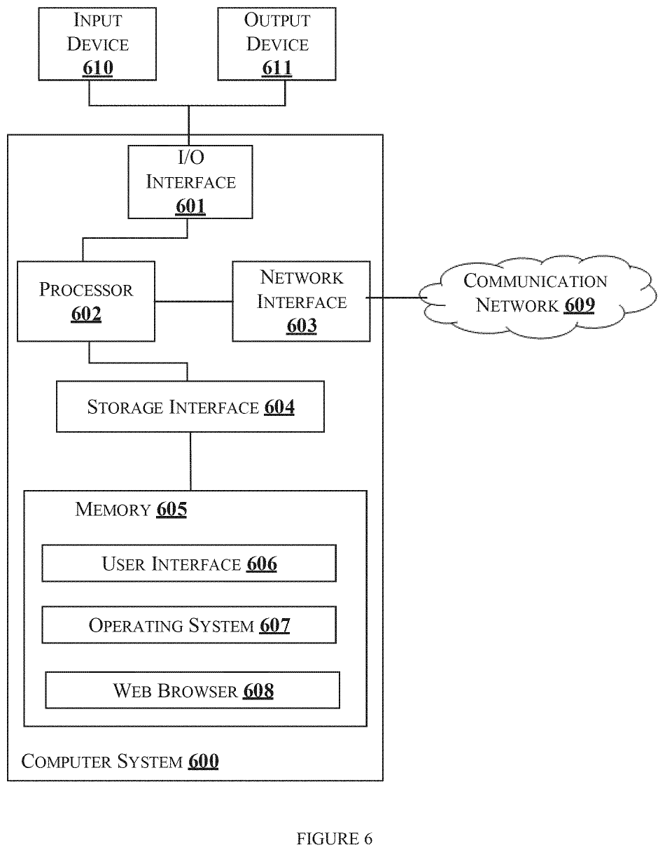

FIG. 6 illustrates a block diagram of an exemplary computer system (600) for implementing embodiments consistent with the present disclosure. In some non-limiting embodiments or aspects, the computer system (600) is used for generating a payment request message based on a preferred payment method. The computer system (600) may comprise a central processing unit (“CPU” or “processor”) (602). The processor (602) may comprise at least one data processor. The processor (602) may include specialized processing units such as integrated system (bus) controllers, memory management control units, floating point units, graphics processing units, digital signal processing units, etc.

The processor (602) may be disposed in communication with one or more input/output (I/O) devices (not shown) via an I/O interface (601). The I/O interface (601) may employ communication protocols/methods such as, without limitation, audio, analog, digital, monaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

Using the I/O interface (601), the computer system (600) may communicate with one or more I/O devices. For example, an input device (610) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (611) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor (602) may be disposed in communication with a communication network (609) via a network interface (603). The network interface (603) may communicate with the communication network (609). The network interface (603) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (609) may include, without limitation, a direct interconnection, local area network (LAN), wide area network (WAN), wireless network (e.g., using Wireless Application Protocol), the Internet, etc. The network interface (603) may employ connection protocols that include, but are not limited to, direct connect, Ethernet (e.g., twisted pair 10/100/1000 Base T), transmission control protocol/internet protocol (TCP/IP), token ring, IEEE 802.11a/b/g/n/x, etc.

The communication network (609) includes, but is not limited to, a direct interconnection, an e-commerce network, a peer to peer (P2P) network, local area network (LAN), wide area network (WAN), wireless network (e.g., using Wireless Application Protocol), the Internet, Wi-Fi®, and such. The first network and the subsequent network may either be a dedicated network or a shared network, which represent an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the subsequent network may include a variety of network devices, including routers, bridges, servers, computing devices, storage devices, etc.

In some non-limiting embodiments or aspects, the processor (602) may be disposed in communication with a memory (605) (e.g., RAM, ROM, etc. not shown in FIG. 6) via a storage interface (604). The storage interface (604) may connect to memory (605) including, without limitation, memory drives, removable disc drives, etc., employing connection protocols such as serial advanced technology attachment (SATA), Integrated Drive Electronics (IDE), IEEE-1394, USB, fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (605) may store a collection of program or database components, including, without limitation, a user interface (606), an operating system (607), a web browser (608), etc. In some non-limiting embodiments or aspects, the computer system (600) may store user/application data, such as, the data, variables, records, etc., as described in this disclosure. Such databases may be implemented as fault-tolerant, relational, scalable, secure databases such as Oracle® or Sybase®.

The operating system (607) may facilitate resource management and operation of the computer system (600). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT WINDOWS® (XP™, VISTA™/7/8, 10 etc.), APPLE® IOS™ GOOGLE® ANDROID™, BLACKBERRY® OS, or the like.

In some non-limiting embodiments or aspects, the computer system (600) may implement the web browser (608) stored program component. The web browser (608) may be a hypertext viewing application, for example MICROSOFT® INTERNET EXPLORER™, GOOGLE CHROME®, MOZILLA® FIREFOX™, APPLE SAFARI®, etc. Secure web browsing may be provided using Secure Hypertext Transport Protocol (HTTPS), Secure Sockets Layer (SSL), Transport Layer Security (TLS), etc. Web browsers (608) may utilize facilities such as AJAX™, DHTML™, ADOBE® FLASH™ JAVASCRIPT™, JAVA™, Application Programming Interfaces (APIs), etc. In some non-limiting embodiments or aspects, the computer system (600) may implement a mail server (not shown in the figure) stored program component. The mail server may be an Internet mail server such as Microsoft Exchange®, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT Exchange®, Post Office Protocol (POP), Simple Mail Transfer Protocol (SMTP), or the like. In some non-limiting embodiments or aspects, the computer system (600) may implement a mail client stored program component. The mail client (not shown in figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., be non-transitory. Examples include RAM, ROM, volatile memory, non-volatile memory, hard drives, Compact Disk (CD) ROMs, DVDs, flash drives, disks, and any other known physical storage media.

The described operations may be implemented as a method, system, or article of manufacture using standard programming and/or engineering techniques to produce software, firmware, hardware, or any combination thereof. The described operations may be implemented as code maintained in a “non-transitory computer-readable medium”, where a processor may read and execute the code from the computer-readable medium. The processor is at least one of a microprocessor and a processor capable of processing and executing the queries. A non-transitory computer-readable medium may include media, such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, and the like), and the like. Further, non-transitory computer-readable media may include all computer-readable media except for a transitory. The code implementing the described operations may further be implemented in hardware logic (e.g., an integrated circuit chip, Programmable Gate Array (PGA), Application ASIC, and the like).

An “article of manufacture” includes non-transitory computer-readable medium and/or hardware logic in which code may be implemented. A device in which the code implementing the described embodiments of operations are encoded may include a computer-readable medium or hardware logic. Of course, those skilled in the art will recognize that many modifications may be made to this configuration without departing from the scope of the disclosure and that the article of manufacture may include suitable information bearing medium known in the art.

The terms “some non-limiting embodiments or aspects”, “embodiment”, “embodiments”, “the embodiment”, “the embodiments”, “one or more embodiments”, “some-non-limiting embodiments or aspects”, and “some non-limiting embodiments or aspects” mean “one or more (but not all) embodiments of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

The terms “including”, “comprising”, “having”, and variations thereof mean “including but not limited to” unless expressly specified otherwise. The enumerated listing of items does not imply that any or all of the items are mutually exclusive unless expressly specified otherwise. The terms “a”, “an”, and “the” mean “one or more” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

The illustrated operations of FIG. 2 and FIG. 4 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

A description of some non-limiting embodiments or aspects with several components in communication with each other does not imply that all such components are required. On the contrary, a variety of optional components is described to illustrate the wide variety of possible embodiments of the disclosure.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method, wherein a computer system facilitates communication of transaction messages between a merchant server and an interoperability server, the method comprising:
receiving a first payment request message from the merchant server, wherein the first payment request message is generated for a transaction between a user and a merchant;
selecting a payment method from a group comprising a plurality of merchant preferred payment methods and a plurality of user preferred payment methods, wherein the selection is based on at least one of the following: transaction information in the first payment request message, one or more rules, or any combination thereof, wherein the plurality of merchant preferred payment methods and the plurality of user preferred payment methods are obtained from a database; and
generating a second payment request message in the selected payment method, wherein the second payment request message is provided to an interoperability server, wherein the transaction is processed in the selected payment method.

2. The computer-implemented method of claim 1, wherein the transaction information in the first payment request message comprises at least one of the following: identity details of the user, a type of the transaction, a transaction amount, a transaction currency, a timestamp of the transaction, location details of the transaction, details of the merchant, a type of merchandise, or any combination thereof.

3. The computer-implemented method of claim 1, wherein the one or more rules comprise at least one of the following: a priority associated with a preferred payment method, one or more business rules, one or more regulatory rules, or any combination thereof.

4. The computer-implemented method of claim 1, further comprising:
receiving a payment response message in a first format from the interoperability server after the transaction is processed;
converting the payment response message in the first format to a second format recognized by the merchant server; and
sending the payment response message in the second format to the merchant server.

5. The computer-implemented method of claim 1, further comprising selecting a first alternate payment method from the group, based on the one or more rules, to complete the transaction when the transaction performed using the selected payment method is declined.

6. The computer-implemented method of claim 1, further comprising providing at least one of the following: a refund of a transaction amount to an account associated with the user in the selected payment method; a chargeback of the transaction amount to an account associated with the merchant in the selected payment method, or any combination thereof.

7. The computer-implemented method of claim 6, further comprising selecting a second alternate payment method from the group for providing the chargeback or the refund of the transaction amount based on the one or more rules, when the chargeback or the refund of the transaction amount is not completed in the selected payment method respectively.

8. A computer-implemented method comprising:
receiving a plurality of user preferred payment methods along with information related to the plurality of user preferred payment methods from a user, wherein the information related to the plurality of user preferred payment methods comprises at least one of the following: a priority associated with each of the plurality of user preferred payment methods, a type of a transaction, an amount of the transaction, a type of merchandise, a type of a merchant, or any combination thereof;
receiving a plurality of merchant preferred payment methods along with information related to the plurality of merchant preferred payment methods from a merchant, wherein the information related to the plurality of merchant preferred payment methods comprises at least one of the following: a priority associated with each of the plurality of merchant preferred payment methods, a type of a transaction, a type of merchandise, location of a transaction, a timestamp of the transaction, an amount of the transaction, or any combination thereof; and
registering the plurality of user preferred payment methods along with the information related to the plurality of user preferred payment methods and the plurality of merchant preferred payment methods along with the information related to the plurality of merchant preferred payment methods in a database, wherein the plurality of preferred payment methods is used to generate a request message during a transaction between the user and the merchant.

9. A computer system for facilitating communication of transaction messages between a merchant server and an interoperability server, the computer system comprising:
one or more processors, and
a memory, wherein the memory stores processor-executable instructions, which, upon execution, cause the one or more processors to:
receive a first payment request message from the merchant server, wherein the first payment request message is generated for a transaction between a user and a merchant;
select a payment method from a group comprising a plurality of merchant preferred payment methods and a plurality of user preferred payment methods, wherein the selection is based on at least one of the following: transaction information in the first payment request message, one or more rules, or any combination thereof, wherein the plurality of merchant preferred payment methods and the plurality of user preferred payment methods are obtained from a database; and
generate a second payment request message in the selected payment method, wherein the second payment request message is provided to an interoperability server, wherein the transaction is processed in the selected payment method.

10. The computer system of claim 9, wherein the one or more processors are further configured to:
receive a payment response message in a first format from the interoperability server after the transaction is processed;
convert the payment response message in the first format to a second format recognized by the merchant server; and
send the payment response message in the second format to the merchant server.

11. The computer system of claim 9, wherein the one or more processors are further configured to select a first alternate payment method from the group, based on the one or more rules, to complete the transaction when the transaction performed using the selected payment method is declined.

12. The computer system of claim 9, wherein the one or more processors are further configured to provide at least one of the following: a refund of a transaction amount to an account associated with the user in the selected payment method, a chargeback of the transaction amount to an account associated with the merchant in the selected payment method, or any combination thereof.

13. The computer system of claim 12, wherein the one or more processors are further configured to select a second alternate payment method from the group for providing the chargeback or the refund of the transaction amount based on the one or more rules, when the chargeback or the refund of the transaction amount is not completed in the selected payment method, respectively.
